(19) United States
(12) Patent Application Publication
(10) Pub. No.: US 2022/0188292 A1
(43) Pub. Date: Jun. 16, 2022

(54) DATA PROCESSING METHOD, APPARATUS, ELECTRONIC DEVICE AND READABLE STORAGE MEDIUM

(71) Applicant: BEIJING BAIDU NETCOM SCIENCE AND TECHNOLOGY CO., LTD., Beijing (CN)

(72) Inventors: Yongfeng CHEN, Beijing (CN); Liya ZHAN, Beijing (CN)

(73) Assignee: BEIJING BAIDU NETCOM SCIENCE AND TECHNOLOGY CO., LTD., Beijing (CN)

(21) Appl. No.: 17/348,159

(22) Filed: Jun. 15, 2021

(30) Foreign Application Priority Data
Dec. 10, 2020 (CN) 202011454517.X

(51) Int. Cl. G06F 16/23; G06F 16/29; G06F 16/9537

(52) U.S. Cl. CPC G06F 16/2365; G06F 16/2379; G06F 16/9537; G06F 16/29

(57) ABSTRACT

The present disclosure provides a data processing method, apparatus, electronic device and readable storage medium and relates to the technical field of data processing and particularly to the technical field of big data. In the present disclosure, the data repetition judgment processing is performed on the raw data according to the address information of each object in the address information of at least two objects in the acquired raw data provided by the user, and then the POI information of the electronic map is obtained according to the data repetition judgment processing result of the data repetition judgment processing, so that the repeated data in the raw data can be output according to the POI information of the electronic map and the data repetition judgment processing result.

### CROSS-REFERENCE TO RELATED APPLICATIONS

The present application claims the priority of Chinese Patent Application No. 202011454517.X, filed on Dec. 10, 2020, with the title of “Data processing method, apparatus, electronic device and readable storage medium.” The disclosure of the above application is incorporated herein by reference in its entirety.

### TECHNICAL FIELD

The present disclosure relates to technical field of data processing, specifically to the technical field of big data, and particularly to a data processing method, apparatus, electronic device and readable storage medium.

### BACKGROUND

When data is input, it inevitably occurs that the data is input repeatedly due to various factors, which causes large trouble in subsequent data processing, for example, problems such as messy data and invalid data in a database, thereby causing reduction of reliability and validity of data.

Therefore, it is desirable to provide a data processing method by which repeated data can be recognized effectively to improve the reliability and validity of the data.

### SUMMARY

The present disclosure provides a data processing method, apparatus, electronic device and readable storage medium.

According to an aspect of the present disclosure, there is provided a data processing method, including: acquiring raw data provided by a user, the raw data comprising address information of at least two objects; performing data repetition judgment processing for the raw data, according to address information of each object in address information of the at least two objects; obtaining POI information of an electronic map, according to a data repetition judgment processing result of the data repetition judgment processing; outputting repeated data in the raw data, according to the POI information of the electronic map and the data repetition judgment processing result.

According to another aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a data processing method, wherein the method includes: acquiring raw data provided by a user, the raw data comprising address information of at least two objects; performing data repetition judgment processing for the raw data, according to address information of each object in address information of the at least two objects; obtaining POI information of an electronic map, according to a data repetition judgment processing result of the data repetition judgment processing; outputting repeated data in the raw data, according to the POI information of the electronic map and the data repetition judgment processing result.

According to a further aspect of the present disclosure, there is provided a non-transitory computer readable storage medium with computer instructions stored thereon, wherein the computer instructions are used for causing a computer to perform a data processing method, wherein the method includes: acquiring raw data provided by a user, the raw data comprising address information of at least two objects; performing data repetition judgment processing for the raw data, according to address information of each object in address information of the at least two objects; obtaining POI information of an electronic map, according to a data repetition judgment processing result of the data repetition judgment processing; outputting repeated data in the raw data, according to the POI information of the electronic map and the data repetition judgment processing result.

As known from the above technical solutions, the data repetition judgment processing is performed on the raw data according to the address information of each object in the address information of at least two objects in the acquired raw data provided by the user, and then the POI information of the electronic map is obtained according to the data repetition judgment processing result of the data repetition judgment processing, so that the repeated data in the raw data can be output according to the POI information of the electronic map and the data repetition judgment processing result. Since the POI information of the electronic map is employed to perform auxiliary repetition judgment processing for the data repetition judgment processing based on the raw data, repeated data in raw data can be effectively screened, thereby improving reliability and validity of the data.

In addition, with the technical solution provided by the present disclosure, manual operation is not required, the operation is simple, errors are not prone to occur, and the efficiency and reliability of data processing can be further improved.

In addition, with the technical solution provided by the present disclosure, the electronic map data can be effectively used so that the utilization rate of the electronic map can be improved.

In addition, with the technical solution provided by the present disclosure, the user's experience can be effectively improved.

It will be appreciated that the Summary part does not intend to indicate essential or important features of embodiments of the present disclosure or to limit the scope of the present disclosure. Other features of the present disclosure will be made apparent by the following description.

### BRIEF DESCRIPTION OF THE DRAWINGS

To describe technical solutions of embodiments of the present disclosure more clearly, figures to be used in the embodiments or in depictions regarding the prior art will be described briefly. Obviously, the figures described below are some embodiments of the present disclosure. Those having ordinary skill in the art appreciate that other figures may be obtained from these figures without making inventive efforts. The figures are only intended to facilitate understanding the solutions, not to limit the present disclosure. In the figures,

FIG. 1 illustrates a schematic diagram of a first embodiment according to the present disclosure;

FIG. 2 illustrates a schematic diagram of a second embodiment according to the present disclosure;

FIG. 3 illustrates a block diagram of an electronic device for implementing a data processing method according to embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as being only exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

It needs to be appreciated that the terminal device involved in the embodiments of the present disclosure includes but is not limited to an intelligent device such as a mobile phone, a Personal Digital Assistant (PDA), a wireless handheld device and a tablet computer. The display device may include but not limited to a device having a display function such as a personal computer and a TV set.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “I” in the text generally indicates associated objects before and after the symbol are in an “or” relationship.

As the market share of fast consumption industry rises stably, the increase speed of E-commerce business have already slowed down, and fast consumption brands also gradually expand their own offline terminal stores to seek for increased merits. Meanwhile, many companies are devoted to meet fast customer's sales and management demands, and provide management and expanded services of sales offline stores. At present, offline business not only needs to solve problems such as “where is the offline store (namely, an object)?” and “is the offline store valid?”, but also needs to solve the problem “is the offline store is repeated?”.

During business expansion, operations of a newly-added offline store also require a database to constantly clean and de-duplicate to ensure real terminal data. Data in databases from different departments of the same company also need to be aligned to create a data medial platform to achieve the target of digitalized management of enterprises. As offline retail stores of enterprises are updated iteratively, the problem of messy historical database is caused and meanwhile invalid data is also blended, for example, the offline store is already closed or does not exist, so that the terminal data cannot provide more valid reference value.

At present, what is mostly used is an extraction technique of address information itself, or a comparison operation of other text information. The comparison and de-duplication of the address information of target offline stores is still in a manually-handled phase, and manual screening is performed by sorting the texts according to the similarity.

However, manual operation can only be performed at a low frequency, and the validity of the database cannot be ensured constantly.

Therefore, the present disclosure provides a data processing method by which repeated data in raw data may be effectively screened through data repetition judgment processing based on raw data and POI information of an electronic map, thereby improving reliability and validity of the data.

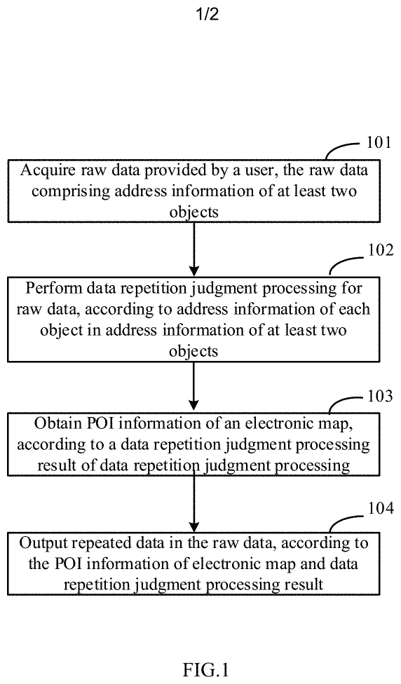

FIG. 1 illustrates a schematic diagram of a first embodiment according to the present disclosure.

101: acquiring raw data provided by a user, the raw data comprising address information of at least two objects.

The so-called raw data may be address data of offline stores in one or more databases designated by the user, or address data of offline stores input by the user. This is particularly limited in the present embodiment.

102: performing data repetition judgment processing for the raw data, according to the address information of each object in the address information of the at least two objects.

103: obtaining Point of Interest (POI) information of an electronic map, according to a repetition judgment processing result of the data repetition judgment processing.

104: outputting repeated data in the raw data, according to the POI information of the electronic map and the repetition judgment processing result.

It needs to be appreciated that subjects for executing 101-104 may partially or totally be an application located in a local terminal, or a function unit such as a plug-in or Software Development Kit (SDK) in the application located in the local terminal, or a processing engine located in a network-side server or a distributed system located on the network side, for example, a processing engine or a distributed system in a data processing server on the side of the network. This is not particularly limited in the present embodiment.

It may be understood that the application may be a native application (nativeAPP) installed on the local terminal, or a web program (webApp) of a browser on the local terminal. This is not particularly limited in the present embodiment.

As such, data repetition judgment processing is performed for the raw data, according to the address information of each object in the address information of the at least two objects in the acquired raw data provided by the user, and then the POI information of the electronic map is obtained, according to a repetition judgment processing result of the data repetition judgment processing, so that repeated data in the raw data can be output, according to the POI information of the electronic map and the repetition judgment processing result. Since the POI information of the electronic map is employed to perform auxiliary repetition judgment processing for the data repetition judgment processing based on the raw data, repeated data in raw data can be effectively screened, thereby improving reliability and validity of the data.

Optionally, in a possible implementation of the present embodiment, at 102, it is specifically possible to extract specific feature data from the address information of the objects, and thereby perform data repetition judgment processing for the raw data according to the specific feature data.

As such, acquiring key features, namely, specific feature data, in the address information of the objects included in the raw data makes it possible to use multiple types of specific feature data and combinations thereof to perform preliminary data repetition judgment processing for the raw data, effectively screen out a portion of repeated data, and provide effective support for further repetition judgment screening.

In the present disclosure, since the data format of the raw data might not be standard upon inputting, it is further feasible to, after 101, further perform filtration processing and labelling processing for the acquired raw data to obtain standardized addresses and labelling results of the objects to extract specific feature data from the standardized addresses of the objects.

An offline store is taken as an example. A standardized address of the offline store may include but not limited to fields such as data ID field, offline store name field, province field, city field, district/county field and detailed address field; a labelling result of the offline store may include but not limited to information for example that whether the offline store is a chain store.

The specific feature data may be at least one of name information of the object and information of administrative divisions at different levels. This is not particularly limited in the present disclosure. For example, name information of an object such as the name of the offline store, and information of administrative divisions of the object at levels of province, city, district/county, town, sub-district, and street.

Since the name of a city is usually unique a, preferably, the city may be taken as feature address data. Specifically, the extracted specific feature data may be taken as a reference address as a judgment basis for subsequent data repetition judgment processing.

For example, the city information may be extracted directly from the city field in the standardized address.

Alternatively, for another example, province information and city information may be specifically extracted from the detailed address field in the standardized address.

Alternatively, for another example, specifically, the district/county information may be extracted from the district/county field in the standardized address, and then the district/county information may be used to reversely infer the city information.

After the specific feature data is acquired, the extracted specific feature data may be taken as a reference address to perform data repetition judgment processing on the raw data.

Further, it is possible to further use an object name of the object, the labeling result and the extracted characteristic address data to perform data repetition judgment processing on the raw data.

For example, it is possible to determine whether the offline stores in the raw data are the same store based on the feature address data of the administrative division information at all levels such as city, district/county etc.

Alternatively, for another example, it is possible to determine whether the offline stores in the raw data are the same store based on the labeling result of the raw data, for example, whether it is a chain store, etc., and the names of the offline stores.

Alternatively, for another example, it is possible to perform a scoring process based on a relationship between the names of the stores and the extracted feature address data, and determine whether the offline stores are the same store based on scores resulting from the scoring process.

In an implementation, specifically, a processing result of the data repetition judgment processing may be output according to the data repetition judgment processing. For example, repeated data content and repeated marks in the raw data may be output.

Optionally, in a possible implementation of the present embodiment, at 103, it is specifically possible to request to a database of the electronic map to acquire the POI information of the corresponding electronic map, according to data repetition judgment criteria of the data repetition judgment processing, and according to the data repetition judgment processing result of the data repetition judgment processing.

As such, through different data repetition judgment criteria for the data repetition judgment processing, it is possible to selectively obtain the POI information of the corresponding electronic map from the database of the electronic map, effectively avoid the problem of the increase of the processing burden of the server caused by frequent requests to the database of the electronic map for the POI information, and thereby improve the acquisition efficiency and utilization efficiency of the POI information.

In a specific implementation, if the data repetition judgment criterion used in the data repetition judgment processing is low, for example, if the data repetition judgment policy is designed very loosely and data are judged repetitious if they are the same in tiny aspects, a case might occur where misjudgment happens. At this time, it is specifically possible to request to the database of the electronic map to acquire the POI information of the electronic map corresponding to the data repetition judgment processing result, for further verification of the data repetition judgment processing result to determine the repeated data in the raw data.

In another specific implementation, if the data repetition judgment criterion used in the data repetition judgment processing is high, for example, if the data repetition judgment policy is designed very strict, and the data are judged repetitious only when a majority of the data are the same, a case might occur where data repetition is missed upon judgment. At this time, it is specifically possible to request to the database of the electronic map to acquire the POI information of the electronic map corresponding to other data in the raw data except the data repetition judgment processing result, to recall more repeated data to determine the repeated data in the raw data.

In another specific implementation, whatever data repetition judgment criteria are employed in the data repletion judgment processing, higher or lower, it is specifically possible to request to the database of the electronic map to acquire the POI information of the electronic map corresponding to the raw data, to perform comprehensive judgment for the raw data by further using the POI information corresponding to all the raw data and by comprehensively considering the data repetition judgment processing result and the POI information corresponding to all raw data, to determine the repeated data in the raw data.

In the present implementation, for any raw data that needs to request to acquire the POI information of the electronic map corresponding to the raw data, it is specifically possible to determine position data in the database of the electronic map according to any address information in the raw data, and then perform matching processing in the database of the electronic map according to the determined position data and the object corresponding to the address information. Then, it is possible to perform screening processing for matching processing results of the matching processing according to the address information, to obtain the POI information corresponding to the address information.

Specifically, for any raw data that needs to request to acquire the POI information of the electronic map corresponding to the raw data, it is specifically possible to first search for content in the detailed address field in the determined city according to the content in the detailed address field in the standardized address of the object corresponding thereto. If there is position information, e.g., latitude and longitude information, it is possible to search for the object within a certain distance (e.g., 2 km) around the POI corresponding to the position information, and thereby request for the POI information of the object.

If there is no position information, or if the object is not found from the search, the extracted specific feature data may be further sought for within the determined city; if there is position information e.g., latitude and longitude information, it is possible to search for the object within a certain distance (e.g., 2 km) around the POI corresponding to the position information, and thereby request for the POI information of the object.

If there is no position information, it is possible to further search for the object by searching for the name of the object within the determined city, e.g., the name of the offline store, and thereby request for the POI information of the object.

After the POI information of the object is obtained by requesting to the database of the electronic map, each object might match multiple piece of POI information. At this time, specifically, each piece of POI information may be parsed out for screening processing.

For example, if the administrative division information in the raw data is inconsistent with the administrative division information in the POI information, the POI information is directly excluded, and the POI information in the remaining POI information is respectively compared with the specific feature data extracted from the raw data. Whether the POI information is consistent with the raw data is judged by calculating a similarity parameter between the respective POI information and the specific feature data, for example, a similarity parameter of the detailed address, a similarity parameter of the name of the offline store, etc. For example, if the similarity parameter is greater than or equal to a similarity threshold, the POI information is judged consistent with the raw data, and vice versa. After the inconsistent POI information is deleted, at least one piece of POI information of the object is obtained.

If only one piece of POI information is obtained, the piece of POI information may be directly taken as the POI information of the electronic map.

If more than one piece of POI information is obtained, it is possible to, according to relevant attribute data of these POI information, e.g., tags of the POI information, and the similarity parameter between the respective POI information and the specific feature data, screen from the multiple pieces of POI information to find one piece of POI information most suitable for the object, as the POI information of the electronic map.

Further, a reference direction of the relevant attribute data of the POI information may be adjusted according to characteristics of the industry to which the user belongs, for example, “shopping”, “life services” and so on. If the tag of the POI information cannot be confirmed, the option may be closed without considering the tag of the POI information.

For example, if the similarity parameter is the largest and the attribute data meets the characteristics of the industry to which the user belongs, the POI information is judged consistent with the raw data, and vice versa.

Optionally, in a possible implementation of the present embodiment, at 104, it is specifically feasible to perform update processing for the data repetition judgment processing result according to the POI information of the electronic map and the data repetition judgment processing result, and then according to the data repetition judgment processing result after the update processing, output repeated data content and repeated marks in the raw data, and other data content and data marks in the raw data in addition to the repeated data content.

In this implementation, specifically, different update processing may be performed on the data repetition judgment processing result according to the obtained POI information of the electronic map.

In a specific implementation if the POI information of the electronic map corresponding to the data repetition judgment processing result is acquired by requesting to the database of the electronic map, at this time the obtained POI of the electronic map may be used to perform data repetition judgment processing, further verify the data repetition judgment processing result, and delete a wrong data repetition judgment processing result to determine the repeated data in the raw data.

In another specific implementation, if the POI information of the electronic map corresponding to other data in the raw data in addition to the data repetition judgment processing result is acquired by requesting to the database of the electronic map, at this time the obtained POI information of the electronic map may be used to perform the data repetition judgment processing and recall more repeated data from the raw data corresponding to the POI information to determine the repeated data in the raw data.

In another specific implementation, if the POI information of the electronic map corresponding to all raw data is acquired by requesting to the database of the electronic map, at this time the POI information corresponding to all raw data may be used to comprehensively consider the data repetition judgment processing result and the POI information corresponding to all raw data, and comprehensively judge the raw data to determine the repeated data in the raw data.

After the repeated data in the raw data is determined, marking processing may be performed on the data in the raw data to distinguish the repeated data from non-repeated data.

For example, the data in the raw data is numbered, the repeated data is marked with the same number, and the non-repeated data is marked with different numbers. At this time, it is possible to output the repeated data content and repeated marks (i.e., the same data number) in the raw data, and other data content and data marks (i.e., the data number) in the raw data in addition to the repeated data content.

In this way, update processing is performed for the data repetition processing result of the raw data according to the obtained POI information of the electronic map to effectively improve the reliability and accuracy of the data repetition judgment processing result of the raw data.

Optionally, in a possible implementation of the present embodiment, after 104, it is further possible to output identification information of the POI information of the electronic map corresponding to each data in the raw data to determine other POI information related to the identification information according to the identification information.

For example, the POI information corresponding to other identification information other than the identification information may be sorted according to business needs, as locations for objects in the raw data to develop business, e.g., locations for opening new offline stores.

As such, it is possible to effectively support the user's different business demands by outputting the identification information of the POI information of the electronic map corresponding to each data in the raw data, thereby further ensuring the validity of the user's database information.

In the present embodiment, the data repetition judgment processing is performed on the raw data according to the address information of each object in the address information of at least two objects in the acquired raw data provided by the user, and then the POI information of the electronic map is obtained according to the data repetition judgment processing result of the data repetition judgment processing, so that the repeated data in the raw data can be output according to the POI information of the electronic map and the data repetition judgment processing result. Since the POI information of the electronic map is employed to perform auxiliary repetition judgment processing for the data repetition judgment processing based on the raw data, repeated data in raw data can be effectively screened, thereby improving reliability and validity of the data.

In addition, with the technical solution provided by the present disclosure, manual operation is not required, the operation is simple, errors are not prone to occur, and the efficiency and reliability of data processing can be further improved.

In addition, with the technical solution provided by the present disclosure, the electronic map data can be effectively used so that the utilization rate of the electronic map can be improved.

In addition, with the technical solution provided by the present disclosure, the user's experience can be effectively improved.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, embodiments are respectively described with different emphasis being placed, and reference may be made to related depictions in other embodiments for portions not detailed in a certain embodiment.

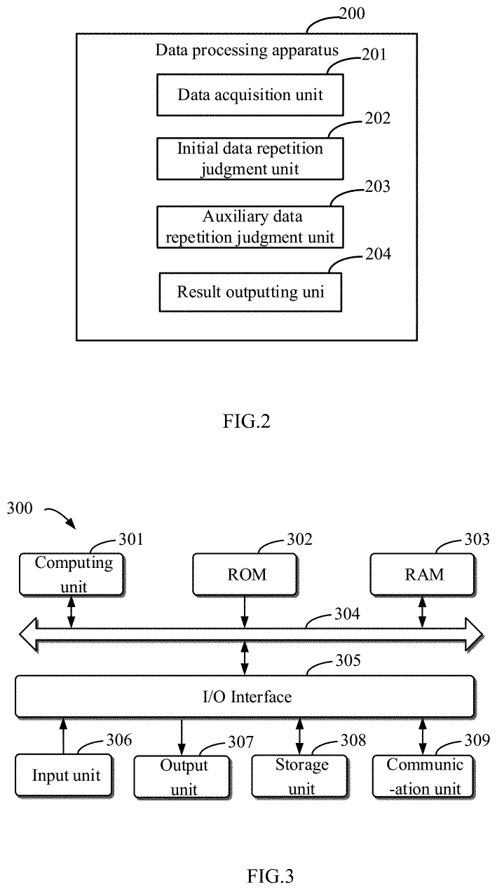

FIG. 2 illustrates a schematic diagram of a second embodiment according to the present disclosure. As shown in FIG. 2, the data processing apparatus 200 in the present embodiment may include a data acquisition unit 201, an initial data repetition judgment unit 202, an auxiliary data repetition judgment unit 203 and a result outputting unit 204. The data acquisition unit 201 is configured to acquire raw data provided by a user, the raw data comprising address information of at least two objects; the initial data repetition judgment unit 202 is configured to perform data repetition judgment processing for the raw data, according to address information of each object in address information of the at least two objects; the auxiliary data repetition judgment unit 203 is configured to obtain POI information of an electronic map, according to a data repetition judgment processing result of the data repetition judgment processing; the result outputting unit 204 is configured to output repeated data in the raw data, according to the POI information of the electronic map and the data repetition judgment processing result.

It needs to be appreciated that the data processing apparatus according to the present embodiment may partially or totally be an application located in a local terminal, or a function unit such as a plug-in or Software Development Kit (SDK) in the application located in the local terminal, or a processing engine located in a network-side server or a distributed system located on the network side, for example, a processing engine or a distributed system in a data processing server on the side of the network. This is not particularly limited in the present embodiment.

It may be understood that the application may be a native application (nativeAPP) installed on the terminal, or a web program (webApp) of a browser on the terminal. This is not particularly limited in the present embodiment.

Optionally, in a possible implementation of the present embodiment, the initial data repetition judgment unit 202 is specifically configured to extract specific feature data from the address information of the objects; and perform data repetition judgment processing for the raw data according to the specific feature data.

Optionally, in a possible implementation of the present embodiment, the auxiliary data repetition judgment unit 203 is specifically configured to request to a database of the electronic map to acquire the POI information of the electronic map corresponding to the data repetition judgment processing result; or request to the database of the electronic map to acquire the POI information of the electronic map corresponding to other data in the raw data except the data repetition judgment processing result; or request to the database of the electronic map to acquire the POI information of the electronic map corresponding to the raw data.

Optionally, in a possible implementation of the present embodiment, as for any address information in the raw data, the auxiliary data repetition judgment unit 203 is further configured to determine position data in the database of the electronic map according to the address information; perform matching processing in the database of the electronic map according to the determined position data and the object corresponding to the address information; and perform screening processing for matching processing results of the matching processing according to the address information, to obtain the POI information corresponding to the address information.

Optionally, in a possible implementation of the present embodiment, the result outputting unit 204 is specifically configured to perform update processing for the data repetition judgment processing result according to the POI information of the electronic map and the data repetition judgment processing result; and according to the data repetition judgment processing result after the update processing, output repeated data content and repeated marks in the raw data, and other data content and data marks in the raw data in addition to the repeated data content.

Optionally, in a possible implementation of the present embodiment, the result outputting unit 204 is further configured to output identification information of the POI information of the electronic map corresponding to each data in the raw data to determine other POI information related to the identification information according to the identification information.

It needs to be appreciated that the method in the embodiment corresponding to FIG. 1 may be implemented by the data processing apparatus according to the present embodiment. Reference may be made to relevant content in the embodiment corresponding to FIG. 1 for detailed depictions. Details will not be presented any more here.

In the present embodiment, the initial data repetition judgment unit performs the data repetition judgment processing on the raw data according to the address information of each object in the address information of at least two objects in the raw data provided by the user and acquired by the data acquisition unit, and then the auxiliary data repetition judgment unit obtains the POI information of the electronic map according to the data repetition judgment processing result of the data repetition judgment processing, so that the repeated data in the raw data can be output according to the POI information of the electronic map and the data repetition judgment processing result. Since the POI information of the electronic map is employed to perform auxiliary data repetition judgment processing for the data repetition judgment processing based on the raw data, repeated data in raw data can be effectively screened, thereby improving reliability and validity of the data.

In addition, with the technical solution provided by the present disclosure, manual operation is not required, the operation is simple, errors are not prone to occur, and the efficiency and reliability of data processing can be further improved.

In addition, with the technical solution provided by the present disclosure, the electronic map data can be effectively used so that the utilization rate of the electronic map can be improved.

In addition, with the technical solution provided by the present disclosure, the user's experience can be effectively improved.

According to embodiments of the present disclosure, the present disclosure further provides an electronic device, a readable storage medium and a computer program product.

FIG. 3 illustrates a schematic diagram of an electronic device 300 for implementing embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 3, the device 300 comprises a computing unit 301 that may perform various appropriate actions and processing based on computer program instructions stored in a read-only memory (ROM) 302 or computer program instructions loaded from a storage unit 308 to a random access memory (RAM) 303. In the RAM 303, there further store various programs and data needed for operations of the device 300. The computing unit 301, ROM 302 and RAM 303 are connected to each other via a bus 304. An input/output (I/O) interface 305 is also connected to the bus 304.

Various components in the electronic device 300 are connected to the I/O interface 305, including: an input unit 306 such as a keyboard, a mouse and the like; an output unit 307 including various kinds of displays and a loudspeaker, etc.; a storage unit 308 including a magnetic disk, an optical disk, and etc.; a communication unit 309 such as a network card, a modem, and a wireless communication transceiver, etc. The communication unit 309 allows the electronic device 300 to exchange information/data with other devices through a computer network such as the Internet and/or various kinds of telecommunications networks.

The computing unit 301 may be various general-purpose and/or special-purpose processing components with processing and computing capabilities. Some examples of computing unit 301 include, but are not limited to, Central Processing Unit (CPU), Graphics Processing Unit (GPU), various dedicated artificial intelligence (AI) computing chips, various computing units that run a machine learning model algorithm, Digital Signal Processing (DSP), and any appropriate processor, controller, microcontroller, etc. The computing unit 301 executes various methods and processes described above, such as the data processing method. For example, in some embodiments, the data processing method may be implemented as a computer software program, which is tangibly contained in a machine-readable medium, such as the storage unit 308. In some embodiments, part or all of the computer program may be loaded and/or installed on the device 300 via the ROM 302 and/or the communication unit 309. When the computer program is loaded into the RAM 303 and executed by the computing unit 301, one or more steps of the data processing method described above may be executed. Alternatively, in other embodiments, the computing unit 301 may be configured in any other suitable manner (for example, with the aid of firmware) to execute the data processing method.

Various implementations of the system and technology described above in the text may be implemented in a digital electronic circuit system, an integrated circuit system, a Field-Programmable Gate Array (FPGA), an Application Specific Integrated Circuit (ASIC), an Application Specific Standard Parts (ASSP), System on Chip (SOC), Complex Programmable Logic Device (CPLD), computer hardware, firmware, software and/or combinations thereof. The various implementations may include: implemented in one or more computer programs which may be executed and/or explained on a programmable system including at least one programmable processor; the programmable processor may be a dedicated or general-purpose programmable processor, may receive data and instructions from a storage system, at least one input device and at least one output device, and transmit the data and instructions to the storage system, the at least one input device and the at least one output device.

The computer program code for implementing the method of the subject matter described herein may be complied with one or more programming languages. These computer program codes may be provided to a general-purpose computer, a dedicated computer or a processor or controller of other programmable data processing apparatuses, such that when the program codes are executed by the processor or controller, the functions/operations prescribed in the flow chart and/or block diagram are caused to be implemented. The program code may be executed completely on a computer, partly on a computer, partly on a computer as an independent software packet and partly on a remote computer, or completely on a remote computer or server.

In the context of the subject matter described herein, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, a hard drive, a Random-Access Memory (RAM), a Read-Only Memory (ROM), an Erasable Programmable Read-Only Memory (EPROM or flash memory), an optical fiber, a Portable Compact Disc Read-Only Memory (CD-ROM), an optical storage device, a magnetic storage device, or any appropriate combination thereof.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a Local Area Network (LAN), a Wide Area Network (WAN), and the Internet.

The computing system may include clients and servers. A client and server are generally remote from each other and typically interact through a communication network. The relationship of client and server arises by virtue of computer programs running on the respective computers and having a client-server relationship to each other. The server may be a cloud server, also referred to as a cloud computing server or a cloud host, and is a host product in a cloud computing service system to address defects such as great difficulty in management and weak service extensibility in a traditional physical host and VPS (Virtual Private Server). The server may also be a server of a distributed system, or a server combined with a block chain.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A data processing method, comprising:
acquiring raw data provided by a user, the raw data comprising address information of at least two objects;
performing data repetition judgment processing for the raw data, according to address information of each object in address information of the at least two objects;
obtaining POI information of an electronic map, according to a data repetition judgment processing result of the data repetition judgment processing; and
outputting repeated data in the raw data, according to the POI information of the electronic map and the data repetition judgment processing result.

2. The method according to claim 1, wherein the performing data repetition judgment processing for the raw data, according to address information of each object in address information of the at least two objects comprises:
extracting specific feature data from the address information of each object; and
performing data repetition judgment processing for the raw data according to the specific feature data.

3. The method according to claim 1, wherein the obtaining POI information of an electronic map, according to a data repetition judgment processing result of the data repetition judgment processing comprises:
requesting to a database of the electronic map to acquire the POI information of the electronic map corresponding to the data repetition judgment processing result; or
requesting to the database of the electronic map to acquire the POI information of the electronic map corresponding to other data in the raw data except the data repetition judgment processing result; or
requesting to the database of the electronic map to acquire the POI information of the electronic map corresponding to the raw data.

4. The method according to claim 1, wherein as for any address information in the raw data, the method further comprises:
determining position data in the database of the electronic map according to the address information;
performing matching processing in the database of the electronic map according to the determined position data and the object corresponding to the address information; and
performing screening processing for matching processing results of the matching processing according to the address information, to obtain the POI information corresponding to the address information.

5. The method according to claim 1, wherein the outputting repeated data in the raw data, according to the POI information of the electronic map and the data repetition judgment processing result comprises:
performing update processing for the data repetition judgment processing result according to the POI information of the electronic map and the data repetition judgment processing result; and
according to the data repetition judgment processing result after the update processing, outputting repeated data content and repeated marks in the raw data, and other data content and data marks in the raw data in addition to the repeated data content.

6. The method according to claim 1, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

7. The method according to claim 2, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

8. The method according to claim 3, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

9. The method according to claim 4, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

10. The method according to claim 5, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

11. An electronic device, comprising:
at least one processor; and
a memory communicatively connected with the at least one processor;
wherein the memory stores instructions executable by the at least one processor, and the instructions are executed by the at least one processor to enable the at least one processor to perform a data processing method, wherein the method comprises:
acquiring raw data provided by a user, the raw data comprising address information of at least two objects;
performing data repetition judgment processing for the raw data, according to address information of each object in address information of the at least two objects;
obtaining POI information of an electronic map, according to a data repetition judgment processing result of the data repetition judgment processing; and
outputting repeated data in the raw data, according to the POI information of the electronic map and the data repetition judgment processing result.

12. The electronic device according to claim 11, wherein the performing data repetition judgment processing for the raw data, according to address information of each object in address information of the at least two objects comprises:
extracting specific feature data from the address information of each object; and
performing data repetition judgment processing for the raw data according to the specific feature data.

13. The electronic device according to claim 11, wherein the obtaining POI information of an electronic map, according to a data repetition judgment processing result of the data repetition judgment processing comprises:
requesting to a database of the electronic map to acquire the POI information of the electronic map corresponding to the data repetition judgment processing result; or
requesting to the database of the electronic map to acquire the POI information of the electronic map corresponding to other data in the raw data except the data repetition judgment processing result; or
requesting to the database of the electronic map to acquire the POI information of the electronic map corresponding to the raw data.

14. The electronic device according to claim 11, wherein as for any address information in the raw data, the method further comprises:
determining position data in the database of the electronic map according to the address information;
performing matching processing in the database of the electronic map according to the determined position data and the object corresponding to the address information; and
performing screening processing for matching processing results of the matching processing according to the address information, to obtain the POI information corresponding to the address information.

15. The electronic device according to claim 11, wherein the outputting repeated data in the raw data, according to the POI information of the electronic map and the data repetition judgment processing result comprises:
performing update processing for the data repetition judgment processing result according to the POI information of the electronic map and the data repetition judgment processing result; and
according to the data repetition judgment processing result after the update processing, outputting repeated data content and repeated marks in the raw data, and other data content and data marks in the raw data in addition to the repeated data content.

16. The electronic device according to claim 11, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

17. The electronic device according to claim 12, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

18. The electronic device according to claim 13, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

19. The electronic device according to claim 14, wherein after outputting repeated data in the raw data, according to the POI information of the electronic map and the data repetition judgment processing result, the method further comprises:
outputting identification information of the POI information of the electronic map corresponding to each data in the raw data to determine other POI information related to the identification information according to the identification information.

20. A non-transitory computer readable storage medium with computer instructions stored thereon, wherein the computer instructions are used for causing a computer to perform a data processing method, wherein the method comprises:
acquiring raw data provided by a user, the raw data comprising address information of at least two objects;
performing data repetition judgment processing for the raw data, according to address information of each object in address information of the at least two objects;
obtaining POI information of an electronic map, according to a data repetition judgment processing result of the data repetition judgment processing;
outputting repeated data in the raw data, according to the POI information of the electronic map and the data repetition judgment processing result.
